(19) United States
(12) Patent Application Publication
(10) Pub. No.: US 2015/0200529 A1
(43) Pub. Date: Jul. 16, 2015

(54) UNDERGROUND HIGH-VOLTAGE ELECTRICAL LINE

(71) Applicant: NEXANS, Paris (FR)

(72) Inventors: David Dubois, Clerques (FR); Martin Henriksen, Mt. Pleasant, SC (US); Jean-Sebastien Rimbault, Saint-Quen (FR)

(21) Appl. No.: 14/585,814

(22) Filed: Dec. 30, 2014

(30) Foreign Application Priority Data
Jan. 15, 2014 (FR) 14 50315

(51) Int. Cl. H02G 13/00; H02G 9/00

(52) U.S. Cl. CPC H02G 13/80; H02G 9/00

(57) ABSTRACT

An underground, three-phase, high-voltage electrical line, includes three phase-conducting cables, each being made up of a succession of cable portions (3a, 3b) interconnected by a cross-bonding junction (4). The line has a connection interface (7) connected to the screen of a first cable portion (3a) and to the screen of a second butted cable portion (3b), a module (6) provided with a junction extension box (14) and equipped with an additional connection interface (8) connected to the connection interface (7) of each junction. A lightning arrester (10) is disposed in the module (6) and is electrically connected to the additional connection interface (8) of the module and the lightning arrester (10) is equipped with a device to monitor its condition disposed in said box (14) connected to a signal generator (16).

### RELATED APPLICATION

This application claims the benefit of priority from French Patent Application No. 14 50315, filed on Jan. 15, 2015, the entirety of which is incorporated by reference.

### BACKGROUND

1. Field of the Invention

The invention relates to an underground high-voltage electrical line.

A three-phase line of this type generally comprises three phase-conducting cables, each made up of a succession of cable portions interconnected. via a cross-bonding junction.

A line of this type is described in patent document EP 2 541 712.

2. Description of Related Art

The three coaxial connection cables originating from the three junctions of the same zone are connected to a cabinet with three coaxial channels with changeover. This cabinet is also underground and is located close to the line in the zone affected by the junctions. It is then possible to accommodate overvoltage protectors or lightning arresters in this cabinet, the function of which is to limit any overvoltages applied to the cross-bonding of the junctions.

This cabinet is generally disposed in a concrete shaft.

According to this document, the main structure of all the junctions is identical and has a standard connection interface connected to the screen of a first cable portion and to the screen of a second cable portion. A variable module provided with an additional connection interface and at least one link cable is suitable for being plugged into the connection interface of the main structure of each junction.

An installation of this type of the lightning arresters poses the following technical problems.

The link between each connection in the cabinet is established by means of a coaxial cable with a large cross section which is designed to resist any short-circuit current and which can have a relatively substantial length.

These connection cables create a voltage barrier between the lightning arresters and the cross-bonding junctions which are to be protected. This causes a reduction in the efficiency of the lightning arresters in the case of high-frequency spectrum fault overvoltages.

Furthermore, in order to check the good condition of the lightning arrester in the cabinet, it is necessary to disconnect the line periodically, open the shaft, open the cabinet and dismantle the lightning arrester in order to test it An operation of this type is laborious, long and costly for the line operator.

Finally, these connection cables are expensive and their installation is also costly. The concrete shaft containing the cabinet, its manufacture and installation. also incur a substantial cost.

### OBJECTS AND SUMMARY

The invention solves these technical problems and to do this proposes an underground, three-phase, high-voltage electrical line, including three phase-conducting cables, each of said conducting cables being made up of a succession of cable portions interconnected by a cross-bonding junction, comprising a connection interface connected co the screen of a first cable portion and to the screen of a second butted cable portion, a module provided with a junction extension box and equipped with an additional connection. interface connected to the connection interface of each junction, said line being characterized in that a lightning arrester is disposed in said module and is electrically connected to said additional connection interface of the module, and in that said lightning arrester is equipped with a device to monitor its condition disposed in said box connected to a signal generator.

The lightning arrester is thus disposed in such a way that it is very close to the interruption of the screens, thereby ensuring its maximum efficiency against overvoltages, even with a high-frequency spectrum.

Moreover, the construction. of a concrete shaft or equivalent is avoided.

The condition. of the lightning arrester can thus be monitored at the surface without the need to excavate the ground and dismantle the box, and without the need to cut the line.

According to one preferred embodiment of the invention, said monitoring device comprises a temperature sensor.

In fact, the deterioration of a lightning arrester is caused by a leakage current which results in a temperature increase, to a level which may be in the region of 100° C.

Said temperature sensor is advantageously a bimetallic thermal contact or a miniaturized electronic temperature sensor, applied to said lightning arrester.

Said signal generator is preferably electrically supplied via a current transformer.

Said signal generator is preferably an acoustic signal generator or a radio frequency identification signal generator.

### BRIEF DESCRIPTION OF THE DRAWINGS

The invention is described in more detail below with reference to figures which merely represent preferred embodiments of the invention.

FIG. 1. is a side view of a cross-bonding junction according to the invention.

FIG. 2 is a detail and perspective view of an open module according to the invention.

FIG. 3 is a detail and perspective view of a module according to a first embodiment of the invention.

FIG. 4 is a detail and perspective view of a module according to a second embodiment of the invention.

### DETAILED DESCRIPTION

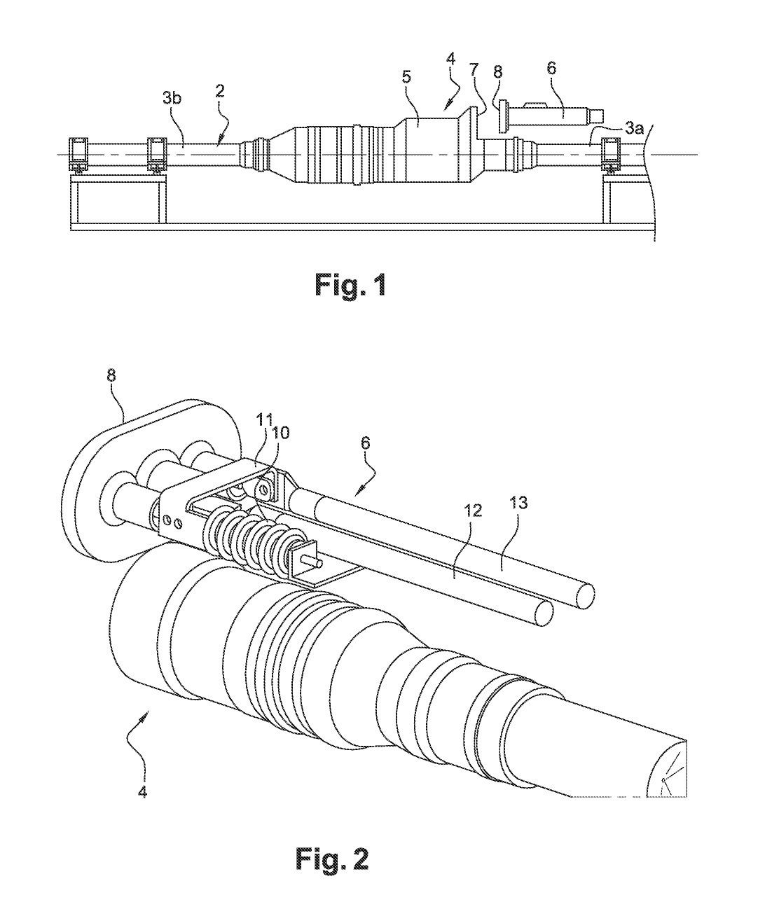

As described in detail in patent document. EP 2 541 712 and shown in FIG. 1, an underground, three-phase, high-voltage electrical line, including three phase-conducting cables 2, each of the conducting cables being made up of a succession of cable portions 3a, 3b interconnected by a cross-bonding junction 4, comprises a connection interface 7 connected to the screen of a first cable portion 3a and to the screen. of a second butted cable portion 3b. A module 6 provided with a junction extension box and equipped with an additional connection. interface 8 is connected, preferably by plugging, to the connection interface 7 of the main structure 5 of each junction.

As shown in FIG. 2 where the module is stripped of its box, according to the invention, a lightning arrester 10 is disposed in the module 6 and is mechanically and electrically connected to the additional connection interface 8 of the module.

A structure of metal sections 11 is mounted on this connection interface 8 and carries, on the one hand, two monopolar connection. cables 12, 13, one being connected to the screen niche first cable portion and the other being connected to the screen of the second cable portion, and, on the other hand, the lightning arrester 10 connected via its terminals to each of the end lugs of these cables, through a suitable design of the sections folded into a U-shape or at right angles, for example.

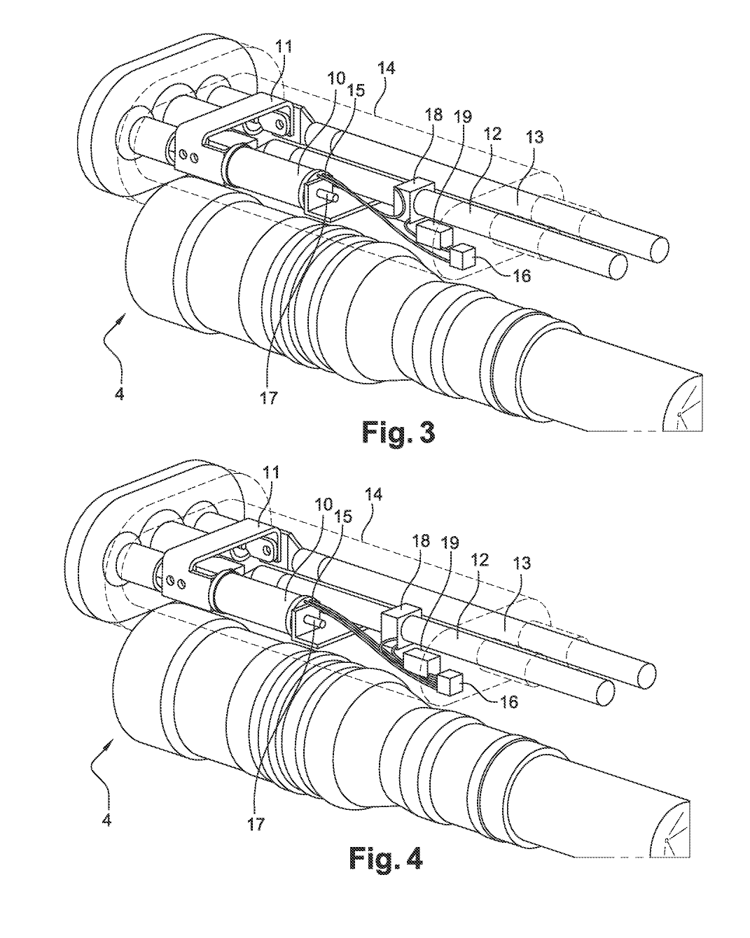

As shown by the mixed broken lines in FIGS. 3 and 4, the module is contained in a junction extension box 14, made from insulating material, and the lightning arrester 10 is equipped with a device for monitoring its condition, disposed in this box.

This monitoring device comprises a temperature sensor 15 adhered directly onto the lightning arrester 10 of which it detects the temperature and connected to a signal generator 16. This temperature sensor 15 is advantageously a bimetallic thermal contact connected to said lightning arrester, more precisely close to a screw-fixing of a terminal 17 of the lightning arrester in one of the sections. This structure of profiles 11 serves to connect the lightning arrester 10 between the two terminals of the cross-bonding of the junction 4.

The signal generator 16 is electrically supplied via a current transformer 18 carried by one of the connection cables 12 and supplied by the primary circuit of this transformer 18 to this cable 12.

This current transformer 18 is connected to an assembly 19 ensuring its operation over a long period. This assembly 19 includes a circuit comprising a diode rectifier bridge for the transformation of the alternating current into direct current, an electromagnetic compatibility filter generally referred to as an “EMC filter” and a switching voltage regulator. This assembly 19 may also include a battery or a super-capacitor, providing the power supply if the current to the primary circuit of the transformer is too weak.

As shown in FIG. 3, according to a first. embodiment, the signal generator 16 is an acoustic signal generator, which may, for example, be a miniature loudspeaker or a piezoelectric module.

In this case, the thermal contact/generator and lightning arrester/transformer/generator links are made up of a single wire. When the thermal contact is closed following a temperature increase, the current activates the signal generator 16, the no emission of which can be detected via the layer of the soil covering the junction, during a line maintenance visit at the surface, thereby enabling a lightning arrester fault to be detected and its replacement to be envisaged.

The assembly 19 supplies electricity to the circuit made up of the temperature sensor 15 and the acoustic signal generator 16.

As shown in FIG. 4, according to a second embodiment, the signal generator 16 is a two-state radio frequency identification (generally known as RFID) signal generator.

In this case, the thermal contact/generator and lightning arrester/transformer/generator links are made up of a double wire. When the thermal contact is open, a signal indicating correct operation is transmitted via radio frequency by the signal generator. When the thermal contact is closed following a temperature increase, a fault signal is transmitted via radio frequency by the signal generator, this signal being able to be detected remotely via the layer of the soil covering the junction, thereby enabling a lightning arrester fault to be detected and its replacement to be envisaged.

The assembly 19 supplies electricity to the circuit made up of the temperature sensor 15 and the radio frequency identification signal generator 16.

A miniaturized electronic temperature sensor preferably associated with an RFID transmitter can be used instead of a bimetallic thermal contact 15. The actual value of the temperature of the lightning arrester can be read remotely via a module including an RFID receive antenna and a portable computer.

The power supply of the thermal contact or the temperature sensor/RFID transmitter assembly is sustained for the entire service life of the construction by means of the assembly comprising the current transformer, diode rectifier, EMC filter, switching-mode power supply and battery or super-capacitor.

1. Underground, three-phase, high-voltage electrical line, including three phase-conducting cables, each of said conducting cables being made up of a succession of cable portions interconnected by a cross-bonding junction, said line comprising:
a connection interface connected to the screen of a first cable portion and to the screen of a second butted cable portion;
a module provided with a junction extension box and equipped with an additional connection interface connected to the connection interface of each junction,
wherein said line has a lightning arrester that is disposed in said module and is electrically connected to said additional connection interface of the module, and in that said lightning arrester is equipped with a device to monitor its condition disposed in said box connected to a signal generator.

2. Electrical line according to claim 1, wherein said monitoring device comprises a temperature sensor.

3. Electrical line according to claim 1, wherein said temperature sensor is a bimetallic thermal contact applied to said lightning arrester.

4. Electrical line according to claim. 2, wherein said temperature sensor is a miniaturized electronic temperature sensor connected to said lightning arrester.

5. Electrical line according to claim 3, wherein said signal generator is electrically supplied via a current transformer.

6. Electrical line according to claim 1, wherein said signal generator is an acoustic signal generator.

7. Electrical line according to claim 1, wherein said signal generator is a radio frequency identification signal generator.
